(19) United States
(12) Patent Application Publication
(10) Pub. No.: US 2005/0079909 A1
(43) Pub. Date: Apr. 14, 2005

(54) Method for player-influenced random distribution of game tokens

(76) Inventor: Lertyos Singhaseni, Woodland Hills, CA (US)

Correspondence Address: SHELDON & MAK, INC, 225 SOUTH LAKE AVENUE, 9TH FLOOR, PASADENA, CA, 91101, US

(21) Appl. No.: 10/686,381

(22) Filed: Oct. 14, 2003

(51) Int. Cl. G06F 17/00

(52) U.S. Cl. 463/22

(57) ABSTRACT

A method for distributing game tokens, such as playing cards, in a game which includes the distribution of game tokens to n players (P₁, P₂, . . . Pₙ), includes the steps of: (a) obtaining from each player Pᵢ a first unit Aᵢ, wherein each Aᵢ is chosen from a finite set of discrete candidate first units; (b) obtaining from each player Pᵢ a second unit Bᵢ, wherein each Bᵢ is chosen from a finite set of discrete candidate second units; (c) deriving a third unit C using a predetermined algorithm where C=f (B₁, . . . , Bₙ); (d) assigning a previously unassigned game token Gᵢ to each player from a predetermined algorithm where Gᵢ=f (Aᵢ, C); and (e) repeating steps (a)-(d) until a predetermined number of game tokens cards are distributed to each player.

### FIELD OF THE INVENTION

This invention relates generally to the distribution of game tokens in a game having multiple players. It relates more specifically, to the random distribution of such game tokens.

### BACKGROUND OF THE INVENTION

The random distribution of game tokens, such as the random distribution of playing cards in a card game has been known for many centuries. Prior to the introduction of digital computer games, the most common method of randomly distributing game tokens comprised the step of physically shuffling the tokens prior to the distribution of those tokens. In games played using digital computers, game tokens are typically randomly distributed using software—akin to a random number generator.

The problem with all known prior art methods of randomly distributing game tokens is that the individual players have no way of knowing whether the distribution of the game tokens has been conducted by a truly random method. Mechanical methods, such as shuffling of a deck of cards, has always been susceptible to cheating by fast fingered card sharks. With respect to games operated using a digital computer, the players cannot be sure that the random token generator has not been intentionally skewed to favor one player or another. This is an especially important problem with respect to computer operated games played on the internet.

Accordingly, there is a need for a method for the random distribution of game tokens where each player can be assured that the distribution of tokens is purely random.

### SUMMARY

The invention satisfied this need. The invention is a method for distributing game tokens to players in a game wherein the game comprises the distribution of game tokens to n players (P₁, P₂, . . . Pₙ), where n is greater than 1. The method comprises the steps of: (a) obtaining from each player Pᵢ a first unit Aᵢ, wherein each Aᵢ is chosen from a finite set of discrete candidate first units; (b) obtaining from each player Pᵢ a second unit Bᵢ, wherein each Bᵢ is chosen from a finite set of discrete candidate second units; (c) deriving a third unit C using a predetermined algorithm where C=f (B₁, . . . , Bₙ); (d) assigning a previously unassigned game token Gᵢ to each player from a predetermined algorithm where Gᵢ=f (Aᵢ, C); and (e) repeating steps (a)-(d) until a predetermined number of game tokens are distributed to each player.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a method of distributing game tokens to players in a game wherein the game comprises a distribution of game tokens to n players, P₁, P₂, . . . Pₙ, where n is greater than 1. The method can be applied to card games where the game tokens are playing cards. The method can also be applied to dominos where the game tokens are the individual dominos and to many other games where game tokens are randomly distributed to players in the game.

The method comprises the steps of: (a) obtaining from each player Pᵢ a first unit Aᵢ, wherein each Aᵢ is chosen from a finite set of discrete candidate first units; (b) obtaining from each player Pᵢ a second unit Bᵢ, wherein each Bᵢ is chosen from a finite set of discrete candidate second units; (c) deriving a third unit C using a predetermined algorithm where C=f (B₁, . . . , Bₙ); (d) assigning a previously unassigned game token Gᵢ to each player from a predetermined algorithm where Gᵢ=f (Aᵢ, C); and (e) repeating steps (a)-(d) until a predetermined number of game tokens are distributed to each player. The term “algorithm” as used in this application is meant to denote a set of rules for determining the identity of a particular parameter. The rules can include a single mathematical formula, a series of formulae and/or one or more predetermined processing steps.

In one embodiment of the invention wherein the game is a card game played with a standard 52 card deck of playing cards, the finite, set of discrete candidate first units is typically 52 in number. In one such embodiment of the invention, each first unit Aᵢ is an integer between 1 and 52. In another such embodiment, each first unit Aᵢ is a playing card from the deck of 52 playing cards.

Each player chooses a first unit Aᵢ in turn, until each of the players has chosen an Aᵢ in that round. Each player also chooses a second unit Bᵢ in turn, until each of the players has chosen an Bᵢ in that round.

After each second unit Bᵢ is chosen in a given round, the third unit C is determined from a predetermined algorithm where C=f (B₁, . . . Bₙ), C being wholly a function of the second units. In one typical embodiment of the invention, each Bᵢ is an integer and C=ΣBᵢ, that is, C is the sum of each of the several second units.

After the third unit C has been determined, a game token Gᵢ is assigned to each player from a predetermined algorithm where Gᵢ=f (Aᵢ, C), each. Gᵢ being wholly a function of Aᵢ and C. In one example, where Aᵢ and Bᵢ are integers, the predetermined algorithm can comprise the steps of adding Aᵢ to C and then repeatedly subtracting from that result the total of the number of candidate first unit until the new result is an integer between 1 and the total number of candidate first units. Game tokens Gᵢ are then assigned to the players by reference to a predetermined matrix which relates each Gᵢ with a unique game token. If the game token to be assigned to a player has already been assigned in the game, a substitute game token is assigned to that player by a predetermined rule or set of rules, such as, by a rule which assigns to such a player the next token in sequence within the matrix.

The above-described steps are repeated round after round until a predetermined number of game tokens are distributed to each player.

In one embodiment of the invention, applicable especially to certain poker games, the method can further comprise the steps of, after the predetermined number of tokens are distributed to each player, a community token H, useable by all players, is chosen by obtaining from each player Pᵢ a new unit Jᵢ and determining the community token H by a predetermined algorithm where H=f (J₁, . . . , Jₙ), H being wholly a function of the new units Jᵢ.

The method is ideally employed using a digital computer to store the various algorithms, calculate the various parameters and assign each game token. Non-digital computing devices can also be used to assist in carrying out the method.

### EXAMPLES

### Example 1

In a first example of the invention, the method is used to distribute cards to two players engaged in a card game requiring the distribution of one card to each player in each round, until five cards are dealt to each player.

The first units Aᵢ, are chosen from integers between 1 and 52. Each second unit, Bᵢ is chosen from a set of integers between 1 and 100. The algorithm for determining the third unit C is as follows: C=ΣBᵢ.

The algorithm for assigning cards Gᵢ as a function of first units Aᵢ and C is as follows: each player's first unit is added to C to yield an intermediate value Iᵢ, i.e., Iᵢ=Aᵢ+C. Thereafter, if Iᵢ is within the range 1-52, the card assigned to the player Pᵢ is chosen from a matrix in which each card is assigned a unique number between 1 and 52. If Iᵢ is greater than 52, the number 52 is repeatedly subtracted from Iᵢ until a value is obtained which is within the range 1-52. That value is used to assign a card to player Pᵢ using the matrix.

After a card is assigned to each player in the first round, the method is repeated four times, whereupon each player is assigned five cards.

### Example 2

In a second example, all the rules are the same as for the first example, except that the first units Aᵢ are chosen from the 52 cards in a standard deck of cards. After each player has chosen a card as his or her Aᵢ, each player is assigned an integer corresponding to that card, the integer being assigned using the same matrix which assigns cards Gᵢ. After each player is assigned an integer corresponding to his or choice for Aᵢ, that integer is used in the assignment of a card Gᵢ by the same algorithm that is used in the first example.

Having thus described the invention, it should be apparent that numerous structural modifications and adaptations may be resorted to without departing from the scope and fair meaning of the instant invention as set forth hereinabove.

1. A method of distributing game tokens to players in a game wherein the game comprises the distribution of game tokens to n players, P₁, P₂, . . . Pₙ, where n is greater than 1, the method comprising the steps of:
(a) obtaining from each player Pᵢ a first unit Aᵢ, wherein each Aᵢ is chosen from a finite set of discrete candidate first units;
(b) obtaining from each player Pᵢ a second unit Bᵢ, wherein each Bᵢ is chosen from a finite set of discrete candidate second units;
(c) deriving a third unit C using a predetermined algorithm where C=f (B₁, . . . , Bₙ);
(d) assigning a previously unassigned game token Gᵢ to each player from a predetermined algorithm where Gᵢ=f (Aᵢ, C); and
(e) repeating steps (a)-(d) until a predetermined number of game tokens cards are distributed to each player.

2. The method of claim 1 wherein the game tokens are playing cards.

3. The method of claim 1 wherein the first units are playing cards.

4. The method of claim 1 wherein the second units are integers.

5. The method of claim 4 wherein C=ΣBᵢ.

6. The method of claim 1 further comprising the steps of, after the predetermined number of game tokens are distributed in step (e), a community token H is chosen by obtaining from each player Pᵢ a new unit Jᵢ and determining the community token H by a predetermined algorithm H=f (J₁, . . . , Jₙ).

7. The method of claim 1 wherein each Aᵢ obtained from step (a) and each Bᵢ obtained from step (b) is inputted into a computer and the computer derives C in step (c) and each assigned game token Gᵢ in step (d).

8. The method of claim 7 wherein the computer is a digital computer.

9. A method of distributing playing cards to players in a game wherein the game comprises the distribution of playing cards to n players, Pᵢ, P₂, . . . , Pₙ, wherein n is greater than 1, the method comprising the steps of:
(a) providing a digital computer;
(b) entering into the computer a first unit Aᵢ, where each Aᵢ, is chosen from a finite set of discrete candidate first units;
(c) entering into the computer a second unit Bᵢ, wherein each Bᵢ is chosen from a finite set of discrete candidates second unit;
(d) deriving, using the computer, a constant C from a predetermined algorithm where C=f (Bᵢ, . . . , Bₙ);
(e) using the computer, assigning a previously unassigned card Gᵢ to each player from a predetermined algorithm where Gᵢ=f (Aᵢ, C); and
(f) repeating steps (b)-(e) until a predetermined number of playing cards are distributed to each player.

10. The method of claim 9 wherein the first units are playing cards.

11. The method of claim 9 wherein the second units are integers.

12. The method of claim 11 wherein C=ΣBᵢ.

13. The method of claim 9 further comprising the steps of, after the predetermined number of playing cards are distributed in step (f), a community playing card H is chosen by obtaining from each player Pᵢ a new unit Jᵢ and, using the computer, determining the community playing card H by a predetermined algorithm where H=f (J₁, . . . , Jₙ).

14. A method of distributing playing cards to players in a game wherein the game comprises the distribution of playing cards to n players, Pᵢ, P₂, . . . , Pₙ, wherein n is greater than 1, the method comprising the steps of:
(a) providing a digital computer;
(b) entering into the computer a first unit Aᵢ, where each Aᵢ, is chosen from a finite set of discrete candidate first units;
(c) entering into the computer a second unit Bᵢ, wherein each Bᵢ is an integer chosen from a finite set of discrete candidate integers;
(d) deriving, using the computer, a constant C from a predetermined algorithm where C=f (Bᵢ, . . . , Bₙ);
(e) using the computer, assigning a previously unassigned card Gᵢ to each player from a predetermined algorithm where Gᵢ=f (Aᵢ, C);
(f) repeating steps (b)-(e) until a predetermined number of playing cards are distributed to each player; and
(g) choosing a community card H after the predetermined number of playing cards are distributed in step (f), a community of playing card H is chosen by obtaining from each player Pᵢ a new unit Jᵢ and, using the computer, determining the community playing card H by a predetermined algorithm where H=f (J₁, . . . , Jᵢ).

15. The method of claim 14 wherein the first units are playing cards.

16. The method of claim 14 wherein C=ΣBᵢ.
